(19) United States
(12) Patent Application Publication
(10) Pub. No.: US 2011/0148651 A1
(43) Pub. Date: Jun. 23, 2011

(54) Substance Communicating Device with Sensor Enabled Connector

(75) Inventors: Michael S. Hendrickson, St. Joseph, MI (US); Joel A. Luckman, Benton Harbor, MI (US); Richard A. McCoy, Stevensville, MI (US)

(73) Assignee: WHIRLPOOL CORPORATION, Benton Harbor, MI (US)

(21) Appl. No.: 12/643,339

(22) Filed: Dec. 21, 2009

(51) Int. Cl. G08B 21/00

(52) U.S. Cl. 340/686.6

(57) ABSTRACT

A substance communicating device for use in conjunction with an appliance or a system including an appliance and a substance communicating device. The appliance has a first service connector component and a first proximity system component. The substance communicating device has a second service connector component operably engageable with the first connector component to permit the communication of a service between the first and second service connector components. The substance communicating device further has a second proximity system component operably associated with the second service connector, the second proximity system component being configured to engage the first proximity system component when the first and second service connector components are engaged to selectively permit the communication of the service between the substance communicating device and the appliance.

### BACKGROUND

Appliances and other useful household equipment are increasingly designed to interact with one another, as well as with a variety of consumer accessory devices. A consumer accessory device may be used, for example, in conjunction with an appliance to enhance or supplement the functionality of the appliance.

### BRIEF SUMMARY

The invention relates to substance communicating devices for use in conjunction with an appliance and couplings system for substance communicating devices.

According to one aspect of the invention, a substance communicating device is used in conjunction with an appliance having a first service connector component and a first contactless proximity system component. The substance communicating device comprises a main body, a service consumer associated with the main body, a service line having a first end coupled with the service consumer and a second end remote from the first end, a second service connector component coupled with the second end of the service line, the second service connector component being operably engageable with the first service connector component to permit the communication of a service between the first and second service connector components, and a second contactless proximity system component operably associated with the second service connector component, the second contactless proximity system component being configured to engage the first contactless proximity system component when the first and second service connector components are engaged to selectively permit the communication of the service between the substance communicating device and the appliance.

According to another aspect of the invention, a system comprises an appliance having a first service connector component, a substance communicating device having a second service connector component operably engageable with the first service connector component, a contactless proximity switch operably associated with one of the first and second service connector components, the contactless proximity switch being configured to selectively permit the communication of a service between the substance communicating device and the appliance, and a contactless proximity actuator associated with the other of the first and second service connector components, the contactless proximity actuator being configured to selectively engage the contactless proximity switch when the first and second service connectors are engaged to permit the communication of a service between the substance communicating device and the appliance.

According to yet another aspect of the invention, an accessory is used in conjunction with an appliance having a first substance communicating device, a first substance service connector component coupled for communicating substance with the first substance communicating device, and a first contactless proximity coupling device. The accessory comprises a main body having a second substance communicating device, a second substance service connector component coupled for communication of substance with the s second substance communicating device, the second substance service connector component being operably engageable with the first substance service connector component to permit the communication of a substance between the first and second substance service connector components, and a second contactless proximity coupling device operably associated with the second substance service connector component, the second service switch component being configured to engage the first contactless proximity coupling device when the first and second substance service connector components are engaged to selectively permit the communication of the substance between the accessory and the appliance.

### BRIEF DESCRIPTION OF THE DRAWINGS

In the drawings:

FIG. 1 is a schematic view of an appliance coupled to, and comprising, a substance communicating device;

FIG. 2 is a schematic view of the substance communicating device of FIG. 1;

FIG. 3 is a schematic illustration showing a substance coupler;

FIG. 4 is a partial cross-sectional view of a proximity sensor enabled substance communication coupling system, showing a first substance communication device positioned for engagement with a second substance communication device;

FIG. 5 is a partial cross-sectional view similar to FIG. 4, showing the first substance communication device engaged with the second substance communication device;

FIG. 6 is a partial cross-sectional view of an alternate proximity sensor energized substance communication coupling system showing a first substance communication device positioned for engagement with a second substance communication device; and

FIG. 7 is a schematic illustration showing a modular system including first and second substance communicating devices.

### DETAILED DESCRIPTION

Referring now to the discussion that follows and also to the drawings, illustrative approaches to the disclosed systems and methods are shown in detail. Although the drawings represent some possible approaches, the drawings are not necessarily to scale and certain features may be exaggerated, removed, or partially sectioned to better illustrate and explain the present invention. Further, the descriptions set forth herein are not intended to be exhaustive or otherwise limit or restrict the claims to the precise forms and configurations shown in the drawings and disclosed in the following detailed description.

The drawings and the following detailed description relate generally relates to substance communicating devices and coupling systems for connecting substance communicating devices. The following definitions apply to terms that may be used in the specification and the claims, unless otherwise noted.

As used herein, a “substance” is a material that may be communicated from one device to another. A substance may include a gas, a liquid, or a solid, or any combination thereof. Examples of substances include, but are not limited to, liquid soap, powdered soap, compressed air, tablets, caplets, water, ice cubes, and a beverage.

As used herein, “substance communication” or a “substance communication service” is a useful provision of a substance from one device to another device. Communicating a substance includes supplying or receiving a substance. As used herein, communication of substance includes both uni-directional and multi-directional communication between any two devices, either directly or through an adapter, as defined herein. Substance communication may be provided in quanta, such as capsules or other doses of substances, batches of discrete items such as tablets, or consumable components.

The term “consumable” and any variation thereof, as used herein, includes any substance that may be consumed by a host, an accessory device, or a user person, such as food, cosmetics, or medicine. The consumable may, for example, be a substance that is used up and must be replenished for subsequent cycles of operation. For a clothes washer, a consumable might be a detergent and/or a softener. For a clothes dryer, a consumable might be an anti-static cloth. For a cooking or refrigeration appliance, the consumable may actually be the article on which the appliance performs its cycle of operation, as in the case of food, later to be consumed by a person. More specific examples of the use of a consumable in appliances include dispensing additives for clothes washers, clothes dryers, or combination washer/dryer appliances. The additives may include, but are not limited to, normal detergents, gentle detergents, dark clothing detergents, cold water detergents, fabric softeners, chlorine bleaches, color-safe bleaches, and fabric enhancement chemistry. Non-limiting examples of fabric enhancers are additives to provide stain resistance, wrinkle resistance, water repellency, insect repellency, color fastness, fragrances, and anti-microbials. Another example of a consumable contemplated is the filters used by an appliance. Refrigerators, dryers, washers, and dishwashers are all known to use filters that are consumed in the sense that they wear out and must be replaced.

The term “substance consumer” and any variation thereof, as used herein, is any useful device that employs, uses, stores, or dispenses a substance in connection with performing a physical or virtual function. A substance consumer may be, for example, a smart utensil, an appliance, a resource controller, such as a water controller, a dispenser, a filter, a water filter, an air filter, a detergent dispenser, a drink dispenser, a detergent cartridge, or a substance holder, such as a bottle or jug.

The term “substance provider” and any variation thereof, as used herein, is any device that is capable of providing or supplying a substance to another device.

As used herein, the term “substance holder” is anything that holds or contains a substance, which may include, but is not limited to, a container, a dispenser, a cartridge, a dish, a bag, a carton, or a conduit.

As used herein, the term “consumable holder” is any substance holder that holds or contains a consumable.

As used herein, the terms “substance communication coupling system” or “substance service connector system” refer to any connector system having at least two separate substance communication coupling system components, each of which is associated with a useful device. The substance communication coupling system components cooperate with one another to couple the useful devices to facilitate communication of a substance between the useful devices.

As used herein, the term “substance switch” is any component used to selectively facilitate the communication of a substance between components of a substance coupling system, such as by drawing the components into engagement or by permitting the flow of a substance from one of the components for transfer to the other of the components.

As used herein, the term “switching valve” is any valve used to selectively facilitate the communication of a substance between components of a substance communication coupling system.

As used herein, the terms “substance line” or “substance pathway” refer to a pathway for transferring a substance from one location to another. The substance line may have any of a variety of configurations depending on the type of substance being transferred, including, but not limited to, a pipe, a conduit, a tube, a channel, or fluidically-aligned supply and receiver ports with a gap therebetween.

As used herein, an “electromagnetic service” is electrical power or data. An electromagnetic service may comprise multiple categories of electromagnetic service, such as electrical power and data in a single signal. An electromagnetic service may be provided continuously, for specified times, for specified amounts, or for the duration of certain events, such as the duration of coupling to provide timed dispensing. Alternatively, an electromagnetic service may be provided in quanta, such, as packets of data. Also alternatively, an electromagnetic service may include data encoded into in waves such as light, radio, and sound.

“Wireless” refers to a type of communication in which power and/or data is transferred over a distance without the use of electrical conductors or wires. For example, electromagnetic waves, light waves, or acoustic waves can be used to carry power and/or data over a distance without using electrical conductors or wires.

“Electrical power communication” is the coupling of at least two devices to supply electrical power from at least one of the devices to the other of the devices, such as through directly connected electronic lines or through wireless power communication (also referred to as wireless power transmission). Wireless power communication may include any type of wireless power communication, including, without limitation for illustration purposes, microwave transmission, laser transmission, and magnetic fields. Exemplary categories of power communication include the type of power, e.g. alternating current (also known as AC) or direct current (also known as DC), supplied to the functional device and variations in the characteristics of the power, such as the voltage or current.

“Data communication” is the coupling of at least two devices to transmit data from at least one of the devices to the other of the devices, such as through directly connected electronic lines or through wireless data communication (also referred to as wireless data transmission). The data may be transmitted as a separate signal or embedded in electrical power communication. Wireless data communication may include any type of wireless data communication, including, without limitation for illustration purposes, wireless network technology (a/k/a Wi-Fi), radio transmission, light transmission, and acoustical transmission. Exemplary categories of data communication include encrypted and unencrypted data. Data communication also includes communication for different protocols, including physical layer protocols and software layer protocols. Examples of physical layer protocols are a wired Ethernet and a wireless (using Wi-Fi) network, both of which may support the same data packet structure. Examples of software layer protocol are Zigbee® and Bluetooth®. Data communication may also be completed by way of an analog mechanical transmission means such as by means of fluidic pulses created by positive pressure systems or vacuum systems or by a mechanical logic transfer means, such as the throwing of switches or levers to actuate or transmit information about a control state.

“Communicating” as used herein with respect to an electromagnetic service means supplying or receiving an electromagnetic service. As used herein, communication of electromagnetic service includes both uni-directional and multi-directional communication between any two devices, either directly or through an adapter, as defined herein.

A “substance communicating device” is any substance holder, substance provider or substance consumer which is capable of communicating substance with another device. Examples of a substance communicating device include a dispenser, a filter, a water filter, an air filter, a detergent dispenser, a drink dispenser, a detergent cartridge, a bottle, a jug, a flavoring dispenser, a steam dispenser, a fragrance dispenser, an food ingredient dispenser, a cycle accessory, and a chemistry dispenser.

A “substance communicating system” is any combination of substance communicating devices capable of communicating a substance therebetween.

A “service connector system” is a connector system having at least two separate service connector components, also referred to as service couplers, each associated with a useful device. The service connector components cooperate with one another to couple the useful devices to facilitate communication of a service between the useful devices. A service connector system may carry multiple services. An electromagnetic service connector system, for example, may be associated with or incorporated into a substance connector system or may be independent of a substance connector system but be associated with the same substance holder, substance provider or substance consumer.

A “switched service connector system” is a service connector system having a switching capability in at least one of the service connector components operable to selectively permit the communication of a service between the components of the service connector system.

A “service switch” is any component used to selectively permit the communication of a service between components of a service connector system. A service switch which selectively permits the communication of a substance may be referred to as a “substance switch”. A service switch may be associated with more than one type of service. For example, an electromagnetic service switch may be associated with, integrated with, or comprise a substance switch or may be independent of a substance switch.

A “service line” is a pathway for transferring a service from one location to another. The service line may have any of a variety of configurations, including, but not limited to, a pipe, a conduit, a wire, a tube, a channel, and a fiber optic cable. More particularly, to transfer electrical power or data service communication, an electromagnetic service line may include an electrically conductive wire, an optical data cable, or a wireless transmission system.

The terms “provide” and “supply” and any variation thereof, is used herein to denote a source of the substance or an electromagnetic service relative to a device receiving the substance or electromagnetic service. Neither term is limited to the original source of the substance or electromagnetic service. A device that provides or supplies the substance or electromagnetic service may simply be passing on the substance or electromagnetic service from the original source. For example, a device that provides water may pass on water it receives from a residential water supply. However, the device may alternatively or additionally provide another substance that originates with the device, such as an additive stored in a reservoir.

The term “receive” and any variation thereof, is used herein to denote receipt of the substance or an electromagnetic service relative to the device providing the substance or electromagnetic service. The term is not limited to the ultimate consumer of the substance or electromagnetic service. The term “receive” is applicable as well to a device that may simply be passing on the substance or electromagnetic service from the source, such as an appliance, to a device that will consume, as hereinafter defined, the substance or electromagnetic service. The device which receives a substance or electromagnetic service is not necessarily the end consumer of the substance or electromagnetic service.

The term “consume” and any variation thereof, as used herein, denotes the act of employing or dispensing at least a portion of the substance or electromagnetic service received in connection with performing a function.

The term “coupled” and any variation thereof, as used herein, includes any type of connection that permits transfer of a substance or an electromagnetic service between two devices. The term “coupled” does not require a physical connection between the two devices, so long as the coupling permits transfer of a substance or an electromagnetic service. The term “coupled” includes both fixed and removable coupling, as well as both continuous and intermittent coupling.

The term “useful device” and any variation thereof, as used herein, is a device that is capable of performing a useful physical or virtual function either alone or in combination with another device.

As used herein, the term “host” is an apparatus that has a primary function independent of providing or receiving a substance. A host may be a substance provider, a substance consumer, or both. For example, the host may be an appliance and the primary function may be performing a series of steps to conduct a useful cycle of operation. The appliance may be a conventional household appliance, such as a refrigerator performing a cooling cycle or an ice making cycle. Other examples of appliances that may be hosts include, but are not limited to, a freezer, a conventional oven, a microwave oven, a dishwashing machine, a stove, a range, an air conditioner, a dehumidifier, a clothes washing machine, a clothes dryer, a clothes refreshing machine, and a non-aqueous washing apparatus, or any combination thereof. Alternatively, the host may be a fixture such as a water softener, a water heater, a furnace, pool water treatment equipment, or an HVAC system. The host may be a small device such as a thermostat, a blender, a mixer, a toaster, a coffee maker, a trash compactor, an air purifier, an iron, a vacuum cleaner, or a robot. The host may alternatively comprise a structural feature of a building, such as a wall, a cabinet, or a door. The host may also provide other services, such as electrical power, electronic data, mechanical power, illumination, heat, or sound.

As used herein, the terms “accessory” or an “accessory device” refer to any useful device which may be coupled to a host and communicate a substance to or from the host. An accessory device may be used primarily in conjunction with a host to enhance, supplement the functionality of the host or may have independent functionality and utility. An accessory device may be a substance provider, a substance consumer, or both. Examples of an accessory device include, but are not limited to, a paper product dispenser, a dry goods dispenser, a bottle opener, a liquid dispenser, and a pill dispenser. An accessory or accessory device may also communicate electromagnetic service with the host.

A “proximity target” is any component or device which may be detected when positioned within a predetermined distance of an associated proximity sensor, defined below. A proximity target may be passive, such as visual target or a magnetic target formed of magnetic or magnetic responsive material. Other examples of passive proximity targets may include a conductive component or surface capable of cooperating with a magnetic field, a current, or a voltage provided by a proximity sensor. A proximity target may alternatively be active or powered such as an electromagnet a generator of a magnetic field, a current, a voltage or an acoustic wave. An active proximity target may alternatively provide a powered readable display or dispense a detectable chemical.

A “proximity sensor” is any component or device which may detect an associated proximity target when the proximity target is within a predetermined distance of the proximity sensor. A proximity sensor may detect, for example, a change in an electromagnetic field, an electromagnetic wave, an acoustic wave, a visual target a chemical component, an electrical signal, a change in voltage, a change in current, a change in frequency, a change in resistance, a change in inductance, a change in capacitance, a mechanical signal, a change in pressure, a displacement, a vibration, and the presence of a chemical. A proximity sensor may be active or passive, such as a magnetic sensor of magnetic or magnet responsive material, or may alternatively be active. Examples of active sensors include active magnetic sensors, light sensors, optical sensors, acoustic sensors, electromagnetic sensors, chemical sensors and thermal sensors. Examples of magnetic sensors include magnets and magnetic responsive components. Examples of optical sensors include infrared sensors, photoelectric sensors, fiber optic sensors, photo resistors, photovoltaic sensors, photo diodes and cameras. Examples of electromagnetic sensors include radio receivers, radar sensors, Hall Effect sensors, inductive sensors, capacitive sensors, variable reluctance sensors and eddy current sensors. Examples of acoustic sensors include ultrasonic sensors and microphones. A contact proximity sensor detects a proximity target by touching the proximity target. A contactless proximity sensor detects the proximity target through a wireless or contactless means. For example, magnetic flux can be used as the signaling mechanism between a contactless proximity sensor and a contactless proximity target.

As used herein, the term “proximity system” is a system that uses a “proximity switch” operated by a plurality of “proximity coupling components,” each associated with a different parent device, for determining that the parent devices are in proximity with each other. Parent devices are usually paired, examples of which include a service provide and a service consumer, a host and an accessory device, and a host and an adapter. Proximity coupling components may include a proximity target associated with one parent device to actively or passively provide an indication of the presence of the one parent device and a proximity sensor associated with the other parent device that is responsive to the presence of the proximity target to activate the proximity switch. The proximity switch may be used to provide a signal or message indicative of the proximity of two parent devices or may directly or indirectly regulate the flow of a service along a service line. The proximity systems disclosed herein employ contactless proximity systems wherein the proximity target and proximity switch use contactless or wireless means to detect the proximity of the two parent devices. In the context of a proximity switch, a proximity target may be considered a “proximity actuator” in the sense that it causes actuation of the proximity switch.

A “plug” as used herein is a generally male electromagnetic service connection component.

A “receptacle” as used herein is a generally female electromagnetic service connection component.

An “adapter” as used herein is an intermediate device that may be provided between a first and second useful device, such as between a host and an accessory, to facilitate the communication of services between the first and second useful devices. An adapter may receive a service from the first useful device and provide a modified version of the service to the second useful device, for example, by providing an electrical power service using a different voltage or providing a data service using a different data structure or signal type. In some applications, multiple adapters may be interposed between two accessory devices. In other applications, three or more devices may be coupled to a single adapter, such as between a host and two accessories. In some applications, the adapter may itself be an accessory device providing a useful function not provided by the accessory devices coupled to it. An adapter may optionally include a transformative component that transforms a service from a service provider to a different service, which is supplied to a service consumer. This may be useful when the service from the service provider is not compatible with the service consumer. The transformative component can be configured to transform the service into a compatible form for the service consumer. Examples of transformative components are protocol converters, power transformers, or other devices that convert substance, energy, or data from a first form to a second form.

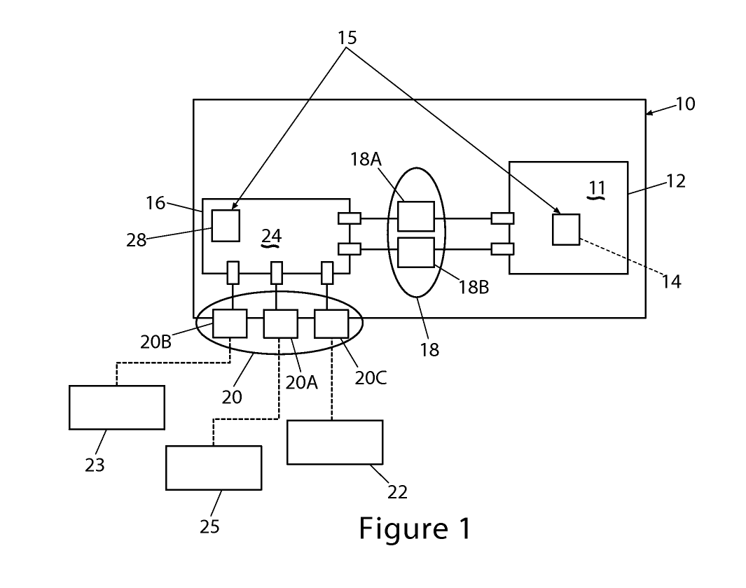

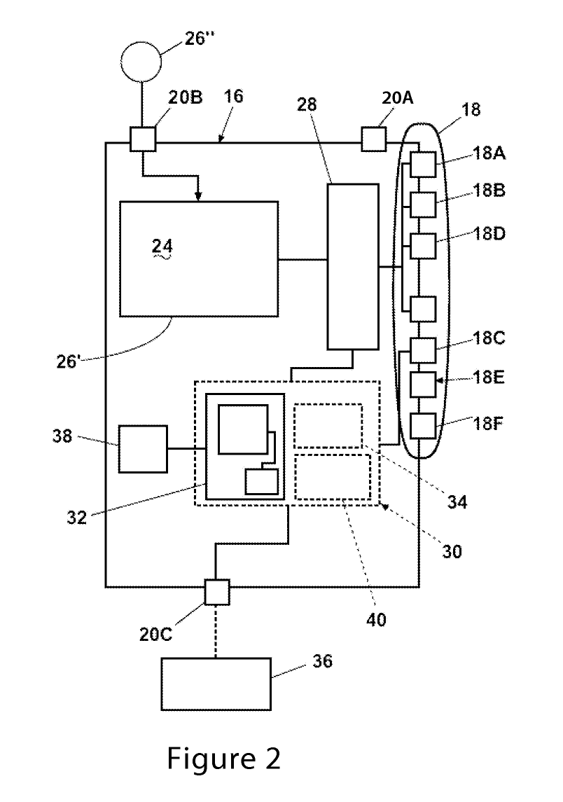

Referring to FIG. 1, a substance handling system 10 is illustrated in schematic form and has a first substance communicating device 12, such as an appliance, with a smart process control apparatus 14, and a second substance communicating device 16, such as a consumable holder. Second substance communicating device 16 may be disposed inside or outside or on the first substance communicating device 12. It may be installed during manufacture and sold with first substance communicating device 12, or it may be made and sold separately as an upgrade or addition. Second substance communicating device 16 may optionally have its own process control apparatus 28, which may be in communication with smart process control apparatus 14 of first substance communicating device 12 or may operate independently. Process control apparatus 14 and 28 may provide at least a portion of the system software architecture and electronics 15 for substance handling system 10. Process control apparatus 14 and 28 may include sensors, actuators, wiring, and other components normally found in an electro-mechanical or mechanical control system. Either process control apparatus 14 or 28 may be able to control itself in limited ways through mechanical techniques. More typically and as illustrated herein, electronics 30, shown in FIG. 2, are connected to the process control apparatus 28 providing additional functionality. Process control apparatus 28 and electronics 30 may be considered in combination as a smart process control apparatus. Smart process control apparatus 14 may also include electronics which interact with the process control apparatus 14 in order to make control decisions based on inputs from sensors or networks and execute those decisions either by network message or the control of actuators within the process control apparatus, but the electronics are not illustrated herein.

First substance communicating device 12 may communicate, through one or more interfaces 18, a substance with second substance communicating device 16 and may as well communicate one or more additional services, such as a data service or a power service. An interface or such as service connector system 18, may include one or more service couplers, such as 18A and 18B for enabling the communication of a one or more services, such as, for example, multiple substance services or a substance service and an electromagnetic service. For example, first substance communicating device 12 may be an automatic clothes washer acting as a host for the second substance communicating device 16, and second substance communicating device 16 may be an additive dispensing accessory capable of dispensing one or more fabric treatment chemicals, such as detergent, bleach or softener, for use by the automatic clothes washer in the processing of a fabric load. As another example, first substance communicating device 12 may be a refrigeration appliance having a water supply and acting as a host for the second substance communicating device 16, and second substance communicating device 16 may be a flavoring dispensing accessory capable of dispensing one or more food flavoring chemicals, such as fruit flavored drink powder, for use by the refrigeration in providing consumers with a flavored drink. As still another example, first substance communicating device 12 may be a refrigeration appliance having a water supply and acting as a host for the second substance communicating device 16, and second substance communicating device 16 may be a drink dispensing accessory holding one or more food flavoring chemicals, such as fruit flavored drink powder, and capable of receiving cooled water from the refrigeration appliance, mixing it with a food flavoring chemical, and dispensing a drink to a consumer. These and other examples are discussed below in more detail.

In general, first substance communicating device 12 may be configured to perform an operation on a physical article 11, such as clothing or food, using a resource such as water, temperature-controlled air (hot or cold), steam, gas, or electricity, provided to first substance communicating device 12 by interfaces, not shown, with a utility, not shown, supplying the resource. Examples of appliances that perform an operation on a physical article include a wide range of device types, including but not limited to, washers, dryers, ovens, ranges, steam cookers, ice makers, refrigerators, drink makers and the like. Articles 11 are the objects upon which a user intends the appliance to perform its cycle of operation. Typical examples as mentioned above would include food and clothing.

Smart process control apparatus 14 is configured to implement and control a cycle comprising at least one operation. Smart process control apparatus 14 may comprise one or more components, not shown, such as electronic control boards, wiring and wiring harnesses, power-supplies, sensors integrated with the electronics as digital or analog inputs, and actuators like valves, relays, heaters, and the like, any or all of which may integrate with the electronics as digital or analog outputs.

Exemplary second substance communicating device 16 is configured to hold, carry, supply, communicate with, or otherwise interact directly with a consumable 24. When performing a cycle of operation on an article 11, first substance communicating device 12 will often use at least one consumable 24. A consumable 24 in one sense comprises a substance, device, or other product that would be at least partially consumed or transformed by first substance communicating device 12 during a cycle of operation on an article 11, such that consumable 24 may be periodically replaced or replenished. The period after which consumable 24 may be replaced or replenished may be, but is not limited to, a single cycle of operation, multiple cycles of operation, an amount of time, or a number of uses. For example, many common washing machines require that a user place a single dose of detergent in a dispenser prior to initiating a cycle of operation. For each subsequent cycle of operation, the user must again place a single dose in the dispenser, as a single dose of detergent is consumed by the washing machine during each cycle of operation.

In some cases, the consumable 24 may be the article 11, on which the first substance communicating device 12 performs the cycle of operation, and the consumable may be subsequently consumed by a user. A consumable 24 may, for example, be anything that would be consumed or otherwise used by a person, such as food, beverages, cosmetics, or medicine. For example, in a cooking or refrigeration appliance, the consumable may be a food item communicated from a dispenser to an appliance, and the cycle of operation performed by the appliance may be heating or cooling the food.

Consumables are to be distinguished from resources, although resources may in some circumstances be “consumed” during a cycle of operation. Resources are commodities that are continuously available to an appliance, and used by the appliance in its cycles of operation on articles 11 that are supplied by external utilities, such as a residential water, power, data or natural gas distribution system, or are available from the ambient environment, such as air. In some cases, a material resource, such as air and water, may also be considered an article 11 as in a refrigerator that chills and dispenses water. That is, water in that instance is a resource (continuously available to the refrigerator from a residential utility), but also an article 11 (intended by the user for the refrigerator to act upon). The cycles of operation performed by the refrigerator would include the chilling and dispensing. Things that hold or supply resources, such as water supply lines or air conduits are not considered consumable holders 16. They would be “resource holders”, which may be supplied by resource providers. In a refrigerator, for example, water supplied to the first substance communicating device 12 would be considered a resource and/or an article 11. If flavoring is mixed with the water supplied to first substance communicating device 12, the flavoring may be considered a consumable 24, and whatever holds/supplies the flavoring is then considered to be second substance communicating device 16.

Consumables are also to be distinguished from parts in an appliance, although parts wear out and need to be replaced or replenished as do consumables. Parts are devices, without which a cycle of operation by the appliance or a principal function of the appliance would be hampered. Examples include valves, actuators, switches, tubes, lamps, wiring, motors, pumps, seals, gears and the like. Consumables, on the other hand, are typically not critical to the operation of the appliance, although they provide a benefit to a user of the appliance. An appliance may typically still operate on an article 11 in some fashion without a consumable, though not necessarily as effectively or efficiently.

Second substance communicating device 16 comprises a device that holds or contains consumable 24. Typically, consumable 24 is contained by a consumable holder. In some cases, second substance communicating device 16 may be nested within one or more other consumable holders. For example, a cartridge holding a consumable may be disposed in a dispenser.

In some cases articles 11 on which the appliance operates may not be contained by a consumable holder, and may not be consumables in the sense herein defined. Rather, articles 11 may be enabled to perform at least some of the functionalities of a consumable and/or a substance communicating device. An example of an article 11 with substance communicating device capabilities is a shirt having a bar code thereon containing information that is directly readable by first substance communicating device 12. The bar code may be, for example, on a performance tag. First substance communicating device 12 may use data and/or information represented by the bar code for use in creating, configuring and selecting the cycle of operation of the appliance. The bar code may be read by first substance communicating device 12 while the shirt is being operated contemporaneously with the cycle of operation.

A performance tag is an information holder either integrally formed or selectively attached to an article 11 and adapted to maintain its integrity over the life of the article 11. For example, a performance tag for clothing would be adapted to maintain its integrity throughout the repeated processes of washing in a washing machine appliance, drying in a dryer, being cleaned at a dry cleaners, being ironed, being left in the sun, and being subjected to the impacts sustained during usage. Examples of impacts sustained during usage for a shirt are those that might occur during a soccer match where the shirt impacts the earth and other players at considerable speeds and forces repeatedly. Likewise, performance tags for dishes would be subjected to similar impacts, and similar wash and dry cycles from a dishwasher. Performance tags integrally formed with fabric items might be sewn in, glued in, woven in, stamped on, or printed on during the manufacturing of the article 11 or by a home machine adapted to integrate the article 11 and the tag. Performance tags integrally formed with dishware might be glued, stamped, printed, embossed, cast, molded, or otherwise formed during the manufacturing of the article 11 or by a home machine adapted to integrate the article 11 and the tag. Performance tags that are selectively attached to an article 11 could be attached by sewing, gluing, pining, sticking, printing, embossing, or other like methods in the home environment for articles 11 not specifically adapted for receiving a performance tag. Performance tags are constructed of any suitable material which may be used to hold encoded information about a cycle structure, or information about a consumable, the description of which is contained herein. Examples of materials for holding the information include magnetic strips, bar codes, and images of encoded data including color patterns, shape patterns, plain texts, numeric identifiers, and the like. An appliance having a cycle architecture and being in communication with a performance tag (as for example by using a consumable reader) may optimize the cycle of operation in the appliance for the article 11 in response to the cycle structure, data about a cycle structure, and/or data about a consumable held by the performance tag. Performance tags may either hold information or hold other information about how to find the information. An example of a performance tag that holds other information is a performance tag holding a URL wherein the data returned when invoking the URL is the information. Further, the appliance may alter or optimize the user experience further by providing information on a user interface in response to the cycle structure, data about a cycle structure, and/or data about a consumable.

Other examples further illustrate the foregoing distinctions. Consider using an oven to cook a turkey in a roasting pan where there is a steam dispenser with a basting cartridge for automatic basting. The turkey is the article 11 upon which the appliance (the oven) performs its cycle of operation (cooking). But the turkey is also a consumable in the sense that it is a food item to be consumed by the user. The basting cartridge would be a consumable holder and its contents a consumable. The water used to generate the steam is a resource, making the steam a changed resource. The roasting pan would be a second consumable holder, holding the turkey. The appliance or the roasting pan or some other device (such as a performance tag described below) may also hold information about the turkey or how to cook a turkey or how to cook a turkey in different kinds of ovens. Such information would be considered information about a consumable and information about a cycle structure.

Consider also a powdered detergent box with a performance tag configured to communicate with an appliance contemporaneously with the dispensing of the detergent to a washer. The washer is the appliance, the detergent is a consumable, and the box is a consumable holder. The performance tag may hold information about the chemistry of the powder, information about cycle structures, and data about cycle structures wherein the information and data are associated with other information comprising appliance types, fabric types, stain types, and the like so that the data and information may be used alone or combined with the other information to create a cycle of operation in response to the data and the information and in response to the user and the user preferences about the cycle of operation, the data, the information, and the other information.

Consider also a detergent pellet with an etched or embossed or imprinted cycle structure enabled to communicate with an appliance contemporaneously with being introduced into a washing machine before or during a wash cycle. Here, the washing machine is an appliance and the detergent pellet is a consumable. There is no separate consumable holder. The cycle structure is intended to effect the cycle of operation (washing). Consider also a detergent pellet having a data pod. The detergent pellet is a consumable, but the data pod is a form of performance tag that could communicate with an appliance contemporaneously with being introduced into the use environment for the purpose of effecting the cycle of operation.

A consumable or a consumable holder or a performance tag or data pod or anything that may hold and convey information (consumable information holder) might comprise one or more cycle structures. A first cycle structure may be associated with a first appliance or first appliance type and a second cycle structure may be associated with a second appliance or a second appliance type such that the appropriate cycle structures are introduced to the appropriate appliance or appliance type when the consumable or consumable holder is in useful communication with the appliances. For example, a frozen food (a consumable) or a package of frozen food (a consumable holder) might have cycle instructions for freezing, defrosting, or preserving cycles in a refrigerator or freezer appliance, and also might have cycle instructions for defrosting, cooking, or warming cycles for a cooking appliance like an oven or microwave.

A consumable information holder may comprise one or more user interface data sets, with or without cycle structures, which may be communicated to a user interface, such as might be on the appliance. User interface data is considered to include anything that may be rendered to be responsive to a user's senses, such as visual displays, audible sounds, and tactile displays. A first user interface data set may be associated with a first appliance or first appliance type and a second user interface data set may be associated with a second appliance or a second appliance type such that the appropriate user interface data are conveyed to a user interface associated with the appropriate appliance or appliance type when the consumable or consumable holder is in useful communication with the appliances. For example, a frozen food (a consumable) or a package of frozen food (a consumable holder) might convey to a refrigerator an expiration date to be rendered on a user interface on the refrigerator. The frozen food or its package might also convey to an oven serving suggestions to be rendered on a user interface on the oven.

Consumables, consumable holders, performance tags, data pods and the like (consumable information holders) may be enabled not only to provide data, but also may be configured to receive and store information associated with the consumable. Exemplary information includes data about a consumable, a cycle structure, data about a cycle structure, tracking the number of times a shirt or a dish is washed, the number of cycles and the parameters thereof which have been executed by or in combination with an appliance and consumable holder. It may also include the types of consumables introduced into the use environment, information entered into an appliance user interface including cycle selections, usage patterns, user information, user identification, other data associated with the cycle of operation of an appliance, and any data held by a data source in communication with the holder, tag, or pod which either the data source writes to the holder, tag, or pod, or any data or the holder, tag, and pod reads from the data source. Such information may be sequentially added to a database on the consumable information holder for later retrieval. For example, a shirt with a performance tag may keep data about how many times it has been washed, about different wash cycles it has been through, and the specific machines it has been washed in.

More specific examples of consumables 24 for use with or by appliances 12 include dispensing additives for laundry washers, dryers, or combination washer/dryer appliances. Other additive examples are provided in the definition of consumables above.

An additive dispenser in this case would be second substance communicating device 16 and may be a single load dispenser that dispenses all of additive contained therein during a single cycle or a bulk dispenser that dispenses only some of the additive contained therein during a single cycle. An appliance comprising a bulk dispenser may meter and dispense the correct amount of additive for each particular load and provide information to the user regarding the remaining amount of additive in the bulk dispenser after dispensing.

Because each additive may have different parameters associated with its use, information about each consumable may be provided with each consumable 24. This information may be provided on the packaging of consumable 24 (i.e. the consumable holder), in consumable 24, or by any other suitable means (performance tag, data pod, user interface, etc.). For example, different additives may have different concentrations, and the amount of a given additive needed for a particular load will vary depending on the concentration of that additive. The amount of a particular additive needed to complete a cycle of operation will also depend on the amount and type of laundry being treated, as well as the condition of the laundry (e.g. soil and stain level). The amount, type, and condition of the laundry may be determined utilizing information supplied by the user, information gathered by sensors associated with the appliance, or information otherwise obtained during the operation of the first substance communicating device 12.

Additional information provided with the consumable may also be used to tailor the cycle of operation to that consumable 24. In a laundry application, the additive will have to be dispensed at the right time during the cycle, such as before, during, or after wash, rinse, spin, or drying. Particular additives may also require that they are dispensed under certain conditions, such as at a given water temperature or air temperature. Additionally, particular additives might require at least one additional step in a cycle for optimal performance. For example, the presence of a particular additive might require that the cycle structure be augmented by inserting an additional ordered collection of steps such as filling at a new temperatures to a new level after spinning, then soaking for an amount of time, then draining, then spinning for a new amount of time at a new spin speed between the original step in the cycle and the last step in the cycle.

The smart process control apparatus 14 or electronics 30 may determine parameters to be used for the cycle of operation or the structure of the appropriate cycle of operation or changes to an existing cycle of operation for different operations based on the information provided with consumable 24, user input, and information obtained by sensors associated with first substance communicating device 12. Exemplary types and sources of information are found in the following table:

| | Information | Information |
|---|---|---|
| Information provided from the | provided by | provided by |
| consumable or consumable holder | the user | appliance sensors |
| New order collection of cycle steps, | Fabric | Soil level |
| actions for each step, a plurality of | type | |
| transition logic expressions for each | | |
| step, and the relationships between | | |
| steps, actions, and logic expressions | | |
| Additive type | Desired | Load weight |
| | cycle | |
| When in cycle to dispense | Fabric type | Load absorption |
| Any special cycle parameters | Load size | Additive remaining |
| | | in dispenser |
| Amount to dispense for a standard | Fabric | Soil level |
| load | condition | |
| | (soil level, | |
| | stains, etc.) | |
| Special dispenser maintenance | Dispensing | None |
| considerations | compartment | |
| | used | |

Another example of a consumable includes filters used by first substance communicating device 12. Refrigerators, dryers, washers, and dishwashers are all known to use filters that are consumed in the sense that they must be replaced after a certain amount of time or usage due to wear and dirtying of the filter. Filters, in particular, depending on the embodiment may be construed as a consumable, a consumable holder, or both. For example, if there is a filter assembly holding a filtering material, then the filter assembly may be considered a consumable holder and the filtering material may be considered a consumable because it is disposed of after it usability is consumed; its life and the life of the consumable holder are significantly different. On the other hand, the filter assembly and the filter material may be integrally formed and introduced and removed from the use environment as a unit. In this case, the assembly and the filter material would be considered both a consumable holder and consumable because the assembly and the filter material comprise functionality and attributes of both consumable holders and consumables.

Consumables may also include food, as mentioned above, and articles of clothing. Such consumables may or may not be contained by a consumable holder. However, non-contained consumables may still have consumable holder functionality in that they may comprise information about the consumable that is retrievable by the appliance. For example, a food item may carry information about itself that is contained in edible ink printed on the surface of the food item.

Returning to the drawings, service connector system 18 may be an internal or external interface configured to couple second substance communicating device 16 and first substance communicating device 12. Substance handling system 10 may also be provided with an interface 20 for removably connecting one or more additional accessory devices 22, 23 or 25. Interface 20 couples accessory devices 22, 23 or 25 to second substance communicating device 16, but it will be appreciated that such an interface may alternatively or additionally be provided on first substance communicating device 12.

Interface 20 may include one or more service couplers, such as 20A, 20B and 20C for enabling the communication of a one or more services provided by any other source or device, such as accessory devices 22, 23 and 25, that may be advantageously used with the first substance communicating device 12 and/or second substance communicating device 16. One or more of the accessory devices 22, 23 and 25 may have a process control apparatus, not shown, that may interact with or become a part of system architecture and electronics 15 when coupled with substance handling system 10.

Accessory device 22 may, for example, comprise a power source, a consumable source, a consumable dispenser, a consumable reader, a data processor, or a component which may facilitate engagement or interaction with second substance communicating device 16. In another example, second substance communicating device 16 may act as an adapter between first substance communicating device 12 and accessory device 22 for communicating a service therebetween. Accessory device 23 may be a consumable reader, including a bar code or RFID tag reader and a microprocessor. Alternatively, a consumable reader may be incorporated into first substance communicating device 12 or second substance communicating device 16 and accessory device 23 may be a sensor for the consumable reader. Accessory device 25 may be a bulk source of consumable 24, such as a large bottle of detergent which provides second substance communicating device 16 with a replenished supply of consumable 24 as second substance communicating device 16 dispenses a dose of substance 24 into first substance communicating device 12.

System architecture and electronics 15 may include software, not shown, enabling at least one of first substance communicating device 12, second substance communicating device 16, or accessory devices 22, 23 or 25 to discover other devices using network messages.

Referring now to FIG. 2, illustrating schematically more details of second substance communicating device 16, service connector system 18 may include a plurality of service couplers 18A-F. Each service coupler may communicate one or more services and may enable one or more functions. For example, service coupler 18A may communicate a consumable 24 to second substance communicating device 16, service coupler 18B may communicate a non-consumable substance to second substance communicating device 16, service coupler 18C may communicate the non-consumable substance back to first substance communicating device 12, service coupler 18D may communicate data between first substance communicating device 12 and second substance communicating device 16, service coupler 18E may couple two power contacts of second substance communicating device 16 to two power contacts of first substance communicating device 12, and service coupler 18F may couple a power takeoff associated with first substance communicating device 12 with a mechanical powered device associated with second substance communicating device 16. Any service communicated through service couplers 18A-18F may be consumed, returned, stored, or passed on to a third device by the device receiving the service. The service may be used to trigger or enable an event, such as to trigger a dispensing event, modify data, or affect a cycle of operation. For example, a mechanical, electrical or data service from first substance communicating device 12 may trigger an actuator in second substance communicating device 16. A substance communicated across a service connector system may be a consumable, a resource or non-consumable substance. Substance and mechanical communication between second substance communicating device 16 and first substance communicating device 12 will normally require a physical coupling. Data, power, illumination, thermal or acoustic communication may require a physical coupling or may occur through a contactless or wireless connection.

In one embodiment, a changed substance is communicated through service coupler 18F. The substance may initially be a resource or a consumable and will have been changed by one of the substance communicating devices prior to being communicated to the other substance communicating device. A changed substance may be one whose properties have been changed by a chemical, thermal, electrical, or other type of process. For example a changed substance may be one that has been heated, cleaned, cooled, mixed with a consumable, or generally treated in such a way that it has at least one property with a different value.

As mentioned above, service coupler 18E may include a power service connector component. A power service connector component may deliver power to a second substance communicating device 16 or it may deliver power to smart process control apparatus 14. The power may be conventional AC at 110 V, DC at 12 V, or another type or amount, such as the power that is transmitted by a USB connection. In some cases, a service connector component may function as both a data and a power source.

Second substance communicating device 16 has an internal source 26′ and/or an external source 26″ of a consumable 24. If second substance communicating device 16 has the optional process control apparatus 28, as shown in FIG. 2, the process control apparatus 28 may be used for controlling the dispensing or communication of consumable 24 from source 26′, or 26″.

Second substance communicating device 16 may have components of system software architecture and electronics 15 shown in FIG. 1. For example, as shown in FIG. 2, second substance communicating device 16 may further comprise electronics 30 configured for communication through service coupler 20C with an accessory device such as a consumables reader 36, or through service connector system 18 with smart process control apparatus 14 of first substance communicating device 12 (see FIG. 1). Electronics 30 may affect the operation of the first substance communicating device 12 by communicating with appliance smart process control apparatus 14 when second substance communicating device 16 is in communication with the first substance communicating device 12 through service coupler 18C. Electronics 30 may be configured to deliver a cycle of operation to first substance communicating device 12. Additionally, electronics 30 may be coupled to the process control apparatus 28 of the second substance communicating device 16 to provide additional functionality to substance handling system 10.

Alternatively, electronics 30 may communicate with portions of system software architecture and electronics 15 in the first substance communicating device for the purposes of observing the cycle of operation and modifying the cycle of operation. Electronics 30 may observe the cycle of operation using an appropriate data collection scheme, such as those disclosed in PCT Application Serial Number US2006/022430, filed 8 Jun. 2006, entitled “Software Architecture System and Method of Communication with, and Management of, at least One Component within a Household Appliance,” supported by software of the system software architecture and electronics 15. These data collection schemes include, but are not limited to: requesting data from system software architecture and electronics 15, such as data stored in a data storage device 34 or data processed by the software architecture received from the first substance communicating device 12 such as unsolicited events from the cycle of operation; and or creating new events that may be received by communicating with a software architecture having a data acquisition (DAQ), not shown, as disclosed and defined in the above referenced PCT patent application and specifying the events to the DAQ for creation by the DAQ.

In addition, electronics 30 may alter a cycle of operation of one of the devices 12, 16, in response to the observations, such as in the manner described in the above referenced PCT patent application. In a first embodiment, electronics 30 may alter the cycle of operation by requesting software in the system software architecture and electronics 15 so that the smart process control apparatus 14 will enter an alternate operating mode enabling electronics 30 to directly control, partially or wholly, the cycle of operation. In a second embodiment, electronics 30 may alter the cycle of operation by making specific requests to system software architecture and electronics 15. In a third embodiment, the electronics may selectively alter the cycle structure using any of the techniques described herein. Electronics 30 may include a controller 32 and software architecture, not shown, similar to system software architecture and electronics 15 of first substance communicating device 12 and/or a software architecture driver (not shown). Electronics 30 may be powered by second substance communicating device 16 or via connection to the first substance communicating device 12. Electronics 30 may further comprise a client 40. Client 40 may comprise a plurality of arbitrary software components, system software architecture and electronics 15, not shown, an instance of system software architecture and electronics 15, a converter, and any other software and data storage and data access functionality.

It will be appreciated that some or all of the above described components of the electronics 30 may alternatively reside in the first substance communicating device 12 in any accessory or other device in data communication with the second substance communicating device.

The second substance communicating device 16 may also have a consumable reader 36, coupled to second substance communicating device 16 by service coupler 20C. In this case, consumable reader 36 is communicatively coupled to the controller 32 and to system software architecture and electronics 15. This enables information about consumable 24 and/or about second substance communicating device 16 to be read from a source of information and transferred into the memory of controller 32 or into the memory of at least one control board within the smart process control apparatus 14 wherein the transferring may be accomplished using system software architecture and electronics 15.

Second substance communicating device 16 may have at least one sensor 38 to sense one or more attributes of a consumable 24 and/or its source 26′ or 26″. Attributes may include, but are not limited to, amount, brand, type, composition, structural form, expiration date, dispensing properties, nutritional information, temperature, pressure, and concentration. To store and inventory such data, second substance communicating device 16 may utilize controller 32. Such information or data may also be conveyed to and/or presented at a user interface in second substance communicating device 16 or first substance communicating device 12.

Process control apparatus 28 of second substance communicating device 16 may be configured to detect functionalities of first substance communicating device 12, modify functionalities of first substance communicating device 12, be controlled by first substance communicating device 12, be controlled by electronics 30, or otherwise exchange data with the smart process control apparatus 14 of first substance communicating device 12 either directly through one or more coupling points of service connector system 18 or indirectly through electronics 30 coupled to the first substance communicating device 12 through service coupler 18C. Process control apparatus 28 may be used for the transmission, dispensing, supplying, or usage of at least one consumable 24 by responding to control signals resulting in the actuating of a mechanical part, such as a valve, conduit, solenoid, sensor, actuator, spring, transmission, motor, or gear, not shown. Additionally, process control apparatus 28 may be configured to modify properties of one or more consumables or resources such as temperature or a chemical property. For example, temperature could be raised by actuating a heater, and chemical properties might be changed by controlling a mixture of at least two consumables and/or resources by using a motor and an auger. Additional auxiliary functionalities not directly related to consumables 24 may be enabled by process control apparatus 28. Process control apparatus 28 may optionally include a mechanism to affect the use of a resource, such as an actuator for a valve.

Second substance communicating device 16 may receive resources from first substance communicating device 12, act on the resources, and return the modified resources to the appliance. For example, in a washing machine or dishwasher, second substance communicating device 16 may receive water from first substance communicating device 12 and return that water to first substance communicating device 12 as grey water or as water mixed with detergent. In this instance, detergent would be consumable 24. Second substance communicating device 16 may thus export modified consumables 24 which have either been operated on by second substance communicating device 16 or that have been operated on by the introduction of at least one resource. Second substance communicating device 16 may also dispense consumable 24 directly to first substance communicating device 12.

Client 40 in electronics 30 may contain a data set linking the model of first substance communicating device 12 or some other functional identifier such as a class identification, application programming interface (API) identification, type, and/or version to the consumables 24 that second substance communicating device 16 may contain. The data set may further link any of these attributes to a plurality of cycles of operation for first substance communicating device 12. The data set may also link cycle modification or cycle operation data or cycle structure data or data for response to a query message to various combinations of appliances 12, consumables 24, and selected cycles. The data set may alternatively be in first substance communicating device 12. The data in the data set may be modified by a message sent by one of the constituents of the substance handling system 10, such as second substance communicating device 16, consumable 24, consumable reader 36, or accessory devices 22, 23, 25.

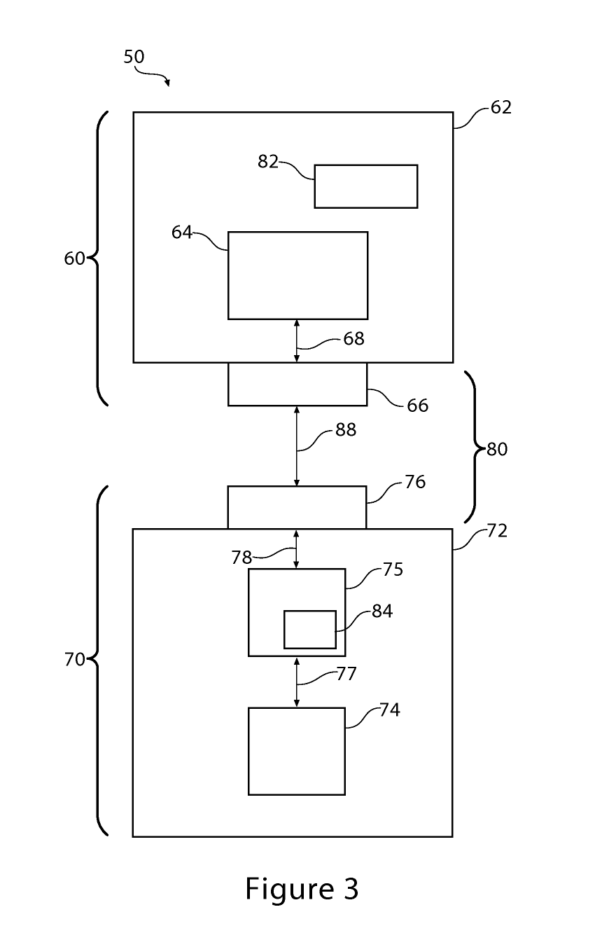

Turning now to FIG. 3, a service coupler 50, providing one possible configuration for at least one of service coupler 18A-18F (see FIG. 2) or 20A-20C (see FIG. 1) is schematically illustrated. A first substance communicating device 60 is connectable to a second substance communicating device 70 for selectively communicating a substance therebetween. First substance communicating device 60 may comprise a host 62 having a substance consumer 64 connected to a first substance service connector component, such as a plug 66, by means of a substance line 68. Second substance communicating device 70 may comprise an accessory device 72 comprising a substance holder having a substance source 74 connected to a second service connector component, such as a receptacle 76, by substance lines 77 and 78 and regulated by a switching valve 75

A substance communication service connector component 80 includes plug 66 and receptacle 76, which are selectively interengageable, as indicated by arrow 88. A wireless proximity target 82 associated with host 62 and a proximity switch 84 associated with accessory device 72 and including a proximity sensor, not shown, for detecting the presence of proximity target 82. Proximity switch 84 is operable to selectively activate switching valve 75 when plug 66 and receptacle 76 are engaged, as determined by the proximity sensor, to permit the flow of the substance from substance provider 74, along substance lines 77 and 78, to receptacle 76, to plug 66, and subsequently along substance line 68 to substance consumer 64.

It will be appreciated that while accessory device 72 is illustrated as including a substance provider and host 62 is illustrated as including a substance consumer, host 62 may alternatively or additionally include a substance provider and accessory device 72 may alternatively or additionally include a substance consumer. It will further be appreciated that while plug 66 is illustrated as being associated with substance consumer 64 and receptacle 76 is illustrated as being associated with substance provider 74, it is contemplated that plug 66 and receptacle 76 may be male or female connector components so long as the components are capable of interengaging to permit the transfer of substance therebetween.

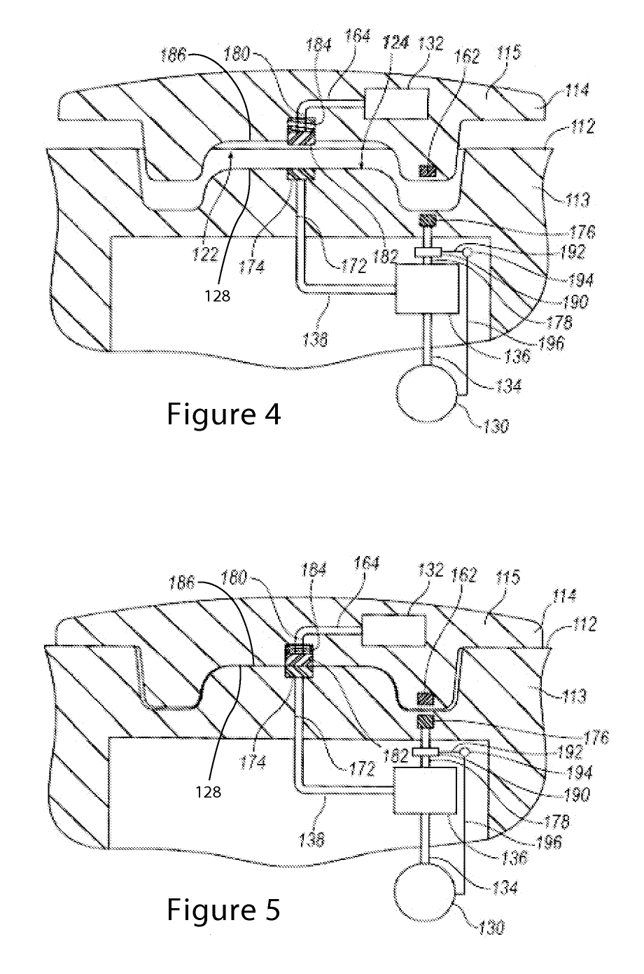

Referring to FIGS. 4 and 5, a more specific example of a substance communicating system is illustrated and includes a first substance communicating device 112 having a first substance connector component 124 and a second substance communicating device 114 having a second substance connector component 122. In the example illustrated, one of the substance communicating devices may, for example, be a host appliance and the other substance communicating device may be an accessory. One of the substance communicating devices may be a substance provider and the other may be a substance consumer.

First substance connector component 124 and second substance connector component 122 have complementary configurations that enable the substance connector components to be coupled to one another, thereby establishing a substance pathway over which desired substances may be transferred between first substance communicating device 112 and second substance communicating device 114. Together, first substance connector component 124 and second substance connector component 122 comprise a substance communication coupling system. Substance connector components 122 and 124 may be integrally formed with second substance communicating device 114 and first substance communicating device 112, respectively, or may be an add-on devices.

First substance communicating device 112 may include a substance providing device 130 connected by a first substance line 134 to a substance flow regulating component 136, which may be, but is not limited to, a switching valve or a pump. A second substance line 138 extends from substance flow regulating component 136 through an aperture 172 in a housing 113 of the first substance communicating device 112 to a first interface 174. It will be appreciated that the precise configuration of interface 174 may vary depending, at least in part, on the substance being provided by substance lines 134 and 138. Substance flow regulating component 136 may be associated with a proximity sensor 176 adapted to activate substance flow regulating component 136 to selectively permit the flow of a substance from first substance line 134 to second substance line 138 in response to the detection of an appropriate proximity target. Proximity sensor 176 may be configured, for example, to sense a magnetic field, an electromagnetic or acoustic wave, a visual target, a temperature or a chemical. Proximity sensor 176 is connected to substance flow regulating component 136 by a line 178 to communicate the detection of an appropriate proximity target to substance flow regulating component 136. The communication along line 178 may be, for example, by means of an electrical signal, an acoustic or electromagnetic wave, or a physical displacement of a linking member.

Second substance communicating device 114 may be provided with a substance consuming device 132 connected by a substance line 164 through a passageway 180 in a housing 115 of the second substance communicating device 114 to a second interface or service connector component 182 engageable with first interface 174. Second substance communicating device 114 may further be provided with a biasing member, such as a spring 184, biasing second interface or service connector component 182 partially through passage 180. Second substance communicating device 114 is further provided with a proximity target 162 chosen for cooperation with proximity sensor 176.

Coupling second substance communicating device 114 to first substance communicating device 112 can be accomplished by positioning second substance communicating device 114 adjacent first substance communicating device 112 in such a manner that second substance connector component 122 is generally aligned with first substance connector component 124, as shown in FIG. 4. First substance connector component 124 and second substance connector component 122 may include various features to facilitate the coupling of second substance communicating device 114 to first substance communicating device 112. For example, first substance connector component 124 may include a raised boss 128 that can engage a corresponding recess 186 of second substance connector component 122.

With substance connector components 124 and 122 engaged, as shown in FIG. 5, proximity target 162 comes into the range of proximity sensor 176 and activates substance flow regulating component 136 to switch on the flow of substance from substance providing device 130 to substance consuming device 132. Spring 184 limits the movement of second interface or service connector component 182 against first interface 174 to facilitate a reliable seal between interfaces 174 and 182. Similarly, detaching second substance connector component 122 from first substance connector component 124 displaces proximity target 162 away from proximity sensor 176, thus signaling substance flow regulating component 136 to switch off the flow. Spring 184 may provide continued engagement of second interface or service connector component 182 with first interface 174 to accommodate a small amount of relative displacement between substance connector components 124 and 122.

Alternatively or in addition to substance flow regulating component 136, an additional switch, such as electrical switch 190, may also be associated with a proximity sensor 176. Electrical switch 190 may be connected by electrical lines 192 to a power supply 194, and may be adapted to control the substance flow regulating component 136 or permit the operation of other features of the first substance communicating device 112. For example, power supply 194 may be connected by electrical lines 196 to substance providing device 130, and electrical switch 190 may selectively open an electrical valve or operate a pump (not shown) associated with substance providing device 130.

Proximity sensor 176 and substance flow regulating component 136 may be unpowered or may rely on a secondary power supply 194 for power. Substance flow regulating component 136 may also be activated or powered by the presence or absence of a static magnetic field. For example, line 178 attached to proximity sensor 176 may operate as a plunger for activating substance flow regulating component 136. In this arrangement, at least one of proximity target 162 and proximity sensor 176 may be formed of a magnetic material. When proximity target 162 is positioned in the vicinity of proximity sensor 176, such as may occur when attaching second substance communicating device 114 to first substance communicating device 112, proximity sensor 176 will be displaced toward proximity target 162 due to the magnetic attraction of the two components. This in turn will withdraw line 178 and activate substance flow regulating component 136. Line 178 may be biased toward substance flow regulating component 136, which will enable substance flow regulating component 136 to be deactivated when second substance communicating device 114 is detached from first substance communicating device 112.

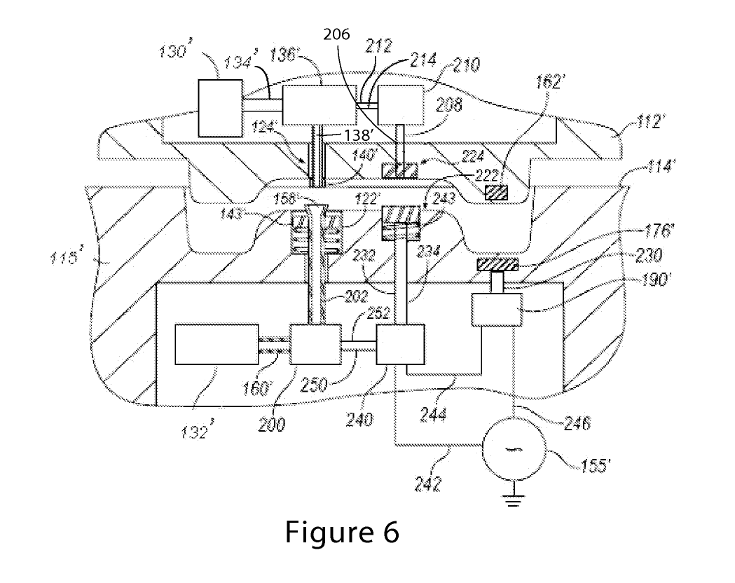

Referring now to FIG. 6, an alternative substance communicating system is illustrated, and includes a first substance communicating device 112′ and a second substance communicating device 114′. First substance communicating device 112′ and second substance communicating device 114′ each have two service connector components. A proximity sensor 176′ and a power supply 155′ are in the second substance communicating device 114′, whereas the proximity sensor 176 and power supply 194 were in the first substance communicating device 112 in the previously described embodiment for FIGS. 4 and 5. This configuration may be used, for example, when the second substance communicating device 114′ is an appliance that is connected to a residential power supply and the first substance communicating device 112′ is an accessory device without an independent source of power.

To avoid confusion, please note that the second substance communicating device 114′ is a substance consumer and is shown below the first substance communicating device 112′, which is a substance provider, in FIG. 6, which the reverse of the configuration shown in FIGS. 4 and 5.

First substance communicating device 112′ has a substance provider 130′ connected by a substance line 134′ to a first flow regulating device 136′, such as a switching valve or a pump, not shown, to a substance line 138′ terminating in a receptacle 140′. Second substance communicating device 114′ has a substance consuming device 132′ connected by a substance line 160′ to a second flow regulating device 200, such as switching valve or a pump, connected in turn to a substance line 202 terminating in a plug 158′ engageable with receptacle 140′.

Second substance communicating device 114′ further has a proximity sensor 176′ having a line 230, such as a power line, a data line, a plunger or other device to communicate with proximity switch 190′. First substance communicating device 112′ has a proximity target 162′ engageable with proximity sensor 176′ to selectively operate proximity switch 190′. Each of these components is similar to similarly named and numbered components described above with reference to FIGS. 4 and 5, except as described below.

Second substance communicating device 114′ further has a substance connector component 122′ and an electromagnetic connector component 222. First substance communicating device 112′ has a substance connector component 124′ and an electromagnetic connector component 224. Substance connector components 124′ and 122′ have complementary configurations that enable them to be coupled to one another, thereby establishing a substance pathway over which desired substances may be transferred between first substance communicating device 112′ and second substance communicating device 114′, and are similar to those described above with reference to FIGS. 4 and 5, such as by including a biasing member 143′ to facilitate a reliable coupling.

Electromagnetic connector components 224 and 222 have complementary configurations that enable them to be coupled to one another, thereby establishing a electrical pathway over which power or data may be transferred between first substance communicating device 112′ and second substance communicating device 114′. It will be appreciated that wireless power or data may alternatively be communicated between the electromagnetic connector components. Together, electromagnetic connector components 224 and 222 comprise an electromagnetic service connector system. The electromagnetic service connector system selectively permits the communication of power or data in response to the actuation of proximity switch 190′ by proximity actuator 162′. As a result of the communications, controller 210 acts as a second proximity switch in that it senses, albeit indirectly, the engagement of device 112′ and 114′ so that it can effectively controller flow regulating devices 136′. In this case, controller 240 acts as a second proximity target or proximity actuator by communicating proximity information between 112′ and 114′ through the electromagnetic service connector system. In the case of a wireless interface between components 224 and 222, the second proximity actuator is a contactless proximity actuator. Electromagnetic connector component 222 may be enclosed within housing 115′ of second substance communicating device 114′. Electromagnetic connector component 224 may be removable or non-removable from first substance communicating device 112′. Electromagnetic connector component 222 may be configured to transfer or receive power, data or both. Electromagnetic connector component 222 may be provided with a biasing member 243 performing a function similar to biasing member 143′ to facilitate a reliable connection with electromagnetic connector component 224.

Electromagnetic connector component 224 may be connected by electrical lines 206 and 208 to a controller 210. Controller 210 is connected by electrical lines 212 and 214 to first flow regulating device 136′ to provide a controlling signal to flow regulating device 136′. Controller 210 may provide the controlling signal in response to signals from other components. Electromagnetic connector component 222 may be connected by electrical lines 232 and 234 to a controller 240, which is selectively operable to provide the electromagnetic service to electromagnetic connector component 222. Controller 240 is connected in series with proximity sensor 176′ and power supply 155′ by electrical lines 242, 244 and 246 such that controller 240 receives a signal when proximity sensor 176′ is closed as a result of the coupling of substance communicating devices 112′ and 114′. Controller 240 may be connected by electrical lines 250 and 252 to a second flow regulating device 200. Additionally, controller 240 may be connected to controller 210 or to the first flow regulating device 136′ for the operable control of the substance communication from substance provider 130′. Electrical lines 244 and 242 might directly connect to the first flow regulating device 136′ via intermediate connections to electromagnetic connector system components 222 and 224 providing a direct control signal from proximity switch 190′ to the first flow regulating device 136′. In another embodiment, electrical lines 244 and 242 might directly connect to the second flow regulating device 200 providing a direct control signal from proximity switch 190′ to the second flow regulating device 200.

Flow regulating device 136′, which may be a normally closed valve requiring power to be opened or a pump requiring power to operate, acts to prevent the communication of substance from first substance communication device 112′. Similarly, normally open proximity switch 190′ and controller 240 prevent the flow of power or data from the second substance communicating device 114′. When second substance communication device 114′ is coupled to first substance communication device 112′, proximity switch 190′ is closed, permitting the flow of power to controller 240. Controller 240 may then selectively supply power or data to the substance holder through connectors 222 and 224.

For some implementations, controller 240 may selectively operate second flow regulating device 200. It will be appreciated that, for some other implementations, controller 240 may be omitted and electrical line 232 may be connected to electrical 242 and electrical line 234 may be connected to electrical line 244 such that power will be provided directly by power supply 155′ to first substance communication device 112′ when proximity switch 190′ is closed by the coupling of substance communication devices 112′ and 114′.

Power or data communicated from second substance communication device 114′ is received by controller 210, which may then selectively operate first flow regulating device 136′ to permit the communication of substance from substance provider 130′ to the substance consuming device 132′. Thus, the control of supply of substance is controlled indirectly by the action of proximity switch 144′.

For some implementations, controller 210 may be omitted and electrical lines 206 and 208 may be connected directly to first flow regulating device 136′ to directly operate flow regulating device upon the delivery of power or data from second substance communicating device 114′. If both controllers 210 and 240 are eliminated, then flow regulating device 136′ is powered directly by power supply 155′ upon the closing of proximity switch 190′.

It will be appreciated that in implementations where controllers 210 or 240 are used, these controllers form a part of the system software architecture and electronics 15 described above with reference to FIGS. 1 and 2 and may incorporate portions of, for example, process control apparatus 14 or 28.

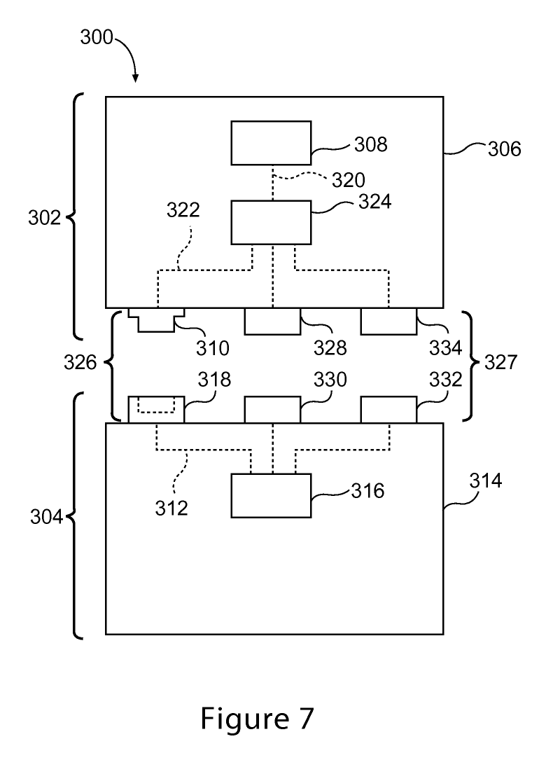

Referring to FIG. 7, a modular system 300 according to another embodiment of the invention is schematically illustrated. The modular system 300 includes a first service communicating device 302 that can be selectively coupled to a second service communicating device 304 for communicating a service therebetween. In one example, each service communicating device 302, 304 can be a substance communicating device, and the service can be a substance.

First service communicating device 302 may comprise a host 306, such as an appliance, having a service provider 308 connected to a first service connector component, such as a plug 310, by service lines 320 and 322, which can optionally be regulated by a service switch 324. If the service being communicated is a substance, the service switch 324 can comprise a switching valve.

Second service communicating device 304 may comprise an accessory device 314 with a main body and a service consumer 316 connected to a second service connector component, such as a receptacle 318, by service line 312.

The modular system 300 further comprises a service connector system 326. The service connector system 326 includes plug 310 and receptacle 318, which are selectively operably interengageable to permit the communication of a service between host 306 and accessory device 314.

The modular system 300 further comprises a proximity system 327. The proximity system 327 includes a first proximity system component 328, such as a proximity target, associated with host 306 and a second proximity system component 330, such as proximity switch including a proximity sensor, associated with accessory device 314 for detecting the presence of first proximity system component 328. The proximity system 327 can comprise a contactless or wireless proximity system; therefore, first and second proximity system components 328, 330 can comprise contactless components. The first and second proximity system components 328, 330 can be engaged with each other when the plug 310 and receptacle 318 are engaged with each other.

Second proximity system component 330 is operably coupled to the service switch 324 and can selectively activate the service switch 324 when plug 310 and receptacle 318 are engaged, as can be determined by the proximity sensor, to permit the communicating of the service from the service provider 308 to the engaged plug 310 and receptacle 318, and then subsequently along service line 312 to service consumer 316.

The modular system 300 can be configured to communicate more than one service. The proximity system 327 can optionally further include a third proximity system component 332 associated with accessory device 314 and a fourth proximity system component 334 associated with host 306 for detecting the presence of third proximity system component 332. The third and fourth proximity system components 332, 334 can be engaged with each other when the plug 310 and receptacle 318 are engaged with each other to selectively permit the communication of another service between host 306 and accessory device 314. The service communicated upon engagement of the third and fourth proximity system 332, 334 can be the same as or different from the service communicated upon engagement of the first and second proximity system components 328, 330. The fourth proximity system component 334 can be operably coupled to the service switch 324 and can selectively activate the service switch 324 when plug 310 and receptacle 318 are engaged to permit the communicating of the service from the service provider 308 to the service consumer 316. Alternatively, a separate service switch, service provider, and service consumer can be provided and associated with the third and fourth proximity system components 332, 334.

It will be appreciated that while accessory device 314 is illustrated as including the service consumer 316 and host 306 is illustrated as including the service provider 308, host 306 may alternatively or additionally include a substance consumer and accessory device 314 may alternatively or additionally include a substance provider. It will further be appreciated that while plug 310 is illustrated as being associated with service provider 308 and receptacle 318 is illustrated as being associated with service consumer 316, it is contemplated that plug 310 and receptacle 318 may be male or female connector components so long as the components are capable of interengaging to permit the transfer of service therebetween.

With regard to the processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

It is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In summary, it should be understood that the invention is capable of modification and variation and is limited only by the following claims.

All defined terms used in the claims are intended to be given their broadest reasonable constructions consistent with the definitions provided herein. All undefined terms used in the claims are intended to be given their broadest reasonable constructions consistent with their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A substance communicating device for use in conjunction with an appliance having a first service connector component and a first contactless proximity system component, the substance communicating device comprising:
a main body;
a service consumer associated with the main body;
a service line having a first end coupled with the service consumer and a second end remote from the first end;
a second service connector component coupled with the second end of the service line, the second service connector component being operably engageable with the first service connector component to permit the communication of a service between the first and second service connector components; and
a second contactless proximity system component operably associated with the second service connector component, the second contactless proximity system component being configured to engage the first contactless proximity system component when the first and second service connector components are engaged to selectively permit the communication of the service between the substance communicating device and the appliance.

2. The substance communicating device according to claim 1, wherein the first contactless proximity system component is a contactless proximity switch and the second contactless proximity system component is a contactless proximity actuator engageable with the contactless proximity switch to actuate the contactless proximity switch when the first and second service connector components are engaged.

3. The substance communicating device according to claim 1, wherein the second contactless proximity system component is a contactless proximity switch and the first contactless proximity system component is a contactless proximity actuator engageable with the contactless proximity switch to actuate the contactless proximity switch when the first and second service connector components are engaged.

4. The substance communicating device according to claim 3 and further comprising a third service connector component, the contactless proximity switch being configured to selectively permit communication of a service to the third service connector component when the first and second service connector components are engaged.

5. The substance communicating device according to claim 4 and further comprising a second contactless proximity actuator operably associated with the second service connector component, the second contactless proximity actuator being configured to actuate a second switch associated with the first service connector component when the first and second service connector components are engaged to selectively permit the communication of another service between the substance communicating device and the appliance.

6. The substance communicating device according to claim 1 wherein the service comprises a substance service, and further wherein the substance communicating device comprises a consumable substance holder.

7. The substance communicating device according to claim 6, wherein the first service connector component comprises a first substance communication component and a first electromagnetic service connector component, and the second service connector component comprises a second substance communication component and a second electromagnetic service connector component operably engageable respectively with the first substance communication component and the first electromagnetic service connector component to permit the communication of a substance and an electromagnetic service between the first and second service connector components.

8. The substance communicating device according to claim 6, wherein the second service switch component is configured to engage the first service switch component when the first and second substance service connector components are engaged to selectively permit the communication of the substance and an electromagnetic service between the consumable substance holder and the appliance.

9. The substance communicating device according to claim 1 and further comprising:
a third contactless proximity system component operably associated with the second service connector component; and
a fourth contactless proximity system component operably associated with the first service connector component;
wherein the third contactless proximity system component is configured to engage the fourth contactless proximity system component when the first and second service connector components are engaged to selectively permit the communication of another service between the substance communicating device and the appliance.

10. The substance communicating device according to claim 1, wherein the substance communicating device comprises a substance consumer.

11. The substance communicating device according to claim 1, wherein the substance communicating device comprises a substance provider.

12. The substance communicating device according to claim 11, wherein the substance provider comprises at least one of a detergent dispenser, a drink dispenser, a bottle, a jug, and an accessory.

13. The substance communicating device according to claim 1 for use in conjunction with an appliance further having a first electromagnetic service connector component, the substance communicating device further comprising:
a second electromagnetic service connector component operably engageable with the first substance service connector component to permit the communication of an electromagnetic service between the first and second substance service connector components.

14. The substance communicating device according to claim 13 wherein the second contactless proximity system component is configured to engage the first contactless proximity system component when the first and second substance service connector components are engaged to selectively permit the communication of the electromagnetic service between the substance communicating device and the appliance between the first and second electromagnetic service connectors.

15. A system comprising:
an appliance having a first service connector component;
a substance communicating device having a second service connector component operably engageable with the first service connector component;
a contactless proximity switch operably associated with one of the first and second service connector components, the contactless proximity switch being configured to selectively permit the communication of a service between the substance communicating device and the appliance; and
a contactless proximity actuator associated with the other of the first and second service connector components, the contactless proximity actuator being configured to selectively engage the contactless proximity switch when the first and second service connectors are engaged to permit the communication of a service between the substance communicating device and the appliance.

16. The system according to claim 15 and further comprising:
a substance line extending from at least one of the first and second substance service connector components; and
a substance device selectively operable to inhibit the flow of substance along the substance line;
wherein the contactless proximity switch further comprises a first switch engageable with the contactless proximity actuator and a second switch is selectively operated by the first switch to control the substance device.

17. The system according to claim 16, wherein the first and second switch communicate using an electromagnetic service.

18. The system according to claim 15, wherein the appliance further comprises a first electromagnetic service connector component and the substance communicating device further comprises a second electromagnetic service connector component engageable with the first electromagnetic service connector component, wherein the first switch selectively permits the communication of electromagnetic service between the first and second electromagnetic service connector components and the second switch is activated when electromagnetic service is communicated between the first and second electromagnetic service connector components.

19. The system according to claim 15 wherein the substance communicating device comprises at least one of a pump, a valve, a fan, a conveyor, an elevator.

20. The system according to claim 15, wherein the substance communicating device further comprises:
a main body;
a substance consumer associated with the main body; and
a substance line having a first end coupled with the substance consumer and a second end coupled with the second service connector component.

21. The system according to claim 15, wherein the contactless proximity switch is operably associated with the first service connector component and the contactless proximity actuator is operably associated with the second service connector component.

22. The system according to claim 15, wherein the contactless proximity switch is operably associated with the second service connector component and the contactless proximity actuator is operably associated with the first service connector component.

23. The system according to claim 22, wherein the substance communicating device further comprises a third service connector component, the contactless proximity switch being configured to selectively permit communication of a service to the third service connector component when the first and second service connector components are engaged.

24. The system of according to claim 22, further comprising:
a second contactless proximity switch associated with the first service connector component configured to selectively permit the communication of another service between the substance communicating device and the appliance; and
a second contactless proximity actuator operably associated with the second service connector component, the second contactless proximity actuator being configured to actuate a second contactless proximity switch when the first and second service connector components are engaged to selectively permit the communication of the another service between the substance communicating device and the appliance.

25. The system according to claim 24 wherein the substance communicating device comprises a flow regulating device under the operable control of the second contactless proximity switch.

26. The system according to claim 15, wherein the service comprises a substance service and the substance communicating device comprises a consumable substance holder.

27. The system according to claim 26, wherein the contactless proximity switch is configured to selectively permit the communication of an electromagnetic service between the consumable substance holder and the appliance.

28. The system according to claim 27, wherein the first service connector component further comprises a first substance communication connector component and a first electromagnetic service connector component, and the second service connector component further comprises a second substance communication connector component and a second electromagnetic service connector component, wherein the second service connector component is operably engageable with a first service connector component to permit the communication of a substance and an electromagnetic service between the first and second service connector components.

29. The system according to claim 28, wherein the second electromagnetic service connector component is configured to engage the first electromagnetic service connector component when the first and second service connector components are engaged to selectively permit the communication of the substance and an electromagnetic service between the consumable substance holder and the appliance.

30. The system according to claim 15 and further comprising:
a second contactless proximity switch operably associated with one of the first and second service connector components, the second contactless proximity switch being configured to selectively permit the communication of a service between the substance communicating device and the appliance; and
a second contactless proximity actuator associated with the other of the first and second service connector components, the second contactless proximity actuator being configured to selectively engage the second contactless proximity switch when the first and second service connectors are engaged to permit the communication of a service between the substance communicating device and the appliance.

31. The system according to claim 15, wherein the first service connector component comprises a receptacle and the second service connector component comprises a plug.

32. The system according to claim 15, wherein the first service connector component comprises a plug and the second service connector component comprises a receptacle.

33. An accessory for use in conjunction with an appliance having a first substance communicating device, a first substance service connector component coupled for communicating substance with the first substance communicating device, and a first contactless proximity coupling device, the accessory comprising:
a main body having a second substance communicating device;
a second substance service connector component coupled for communication of substance with the second substance communicating device, the second substance service connector component being operably engageable with the first substance service connector component to permit the communication of a substance between the first and second substance service connector components; and
a second contactless proximity coupling device operably associated with the second substance service connector component, the second service switch component being configured to engage the first contactless proximity coupling device when the first and second substance service connector components are engaged to selectively permit the communication of the substance between the accessory and the appliance.

34. The accessory according to claim 33, further comprising an electro-magnetically operated substance switch.

35. The accessory according to claim 34, wherein the second substance communicating device is substance consumer.

36. The accessory according to claim 33, wherein the second substance communicating device is substance provider.

37. The accessory according to claim 36, wherein the substance provider comprises a consumable holder.

38. The accessory according to claim 33, wherein the second contactless proximity coupling device is a contactless proximity sensor.

39. The accessory according to claim 33, wherein the second contactless proximity coupling device is a contactless proximity target.

40. The accessory according to claim 33, and further comprising at least one of a dispenser, a filter, a water filter, an air filter, a detergent dispenser, a drink dispenser, a detergent cartridge, a bottle, a jug, a flavoring dispenser, a steam dispenser, a fragrance dispenser, an food ingredient dispenser, a cycle accessory, and a chemistry dispenser.
